(19) United States
(12) Patent Application Publication
(10) Pub. No.: US 2006/0168072 A1
(43) Pub. Date: Jul. 27, 2006

(54) Image forming device for transmitting and receiving email message and method thereof

(75) Inventor: Hyun-Cheol Park, Suwon-si (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electronics Co., Ltd.

(21) Appl. No.: 11/324,262

(22) Filed: Jan. 4, 2006

(30) Foreign Application Priority Data
Jan. 10, 2005 (KR) 2005-0002169

(51) Int. Cl. G06F 15/16

(52) U.S. Cl. 709/206

(57) ABSTRACT

An image forming device for transmitting and receiving an email message and a method for transmitting and receiving an email message by an image forming device. The image forming device includes a communication unit, a memory unit, an email processing unit, an email preparing unit, and a controller. The communication unit is connected to a network connected to a predetermined terminal device and performs data communication with the terminal device. The memory unit stores a pre-processed data file. The email processing unit detects the content of any email messages that are transmitted from the terminal device and received through the communication unit. The email preparing unit prepares an email message to be transmitted to the terminal device. If the content of the email message includes a data transmission command that requests the sending of a first data file among data files stored in the memory unit, the controller controls the email preparing unit and the communication unit to prepare and transmit an email message attaching the first data file. Accordingly, it is possible for a user to easily copy data from the image forming apparatus to the terminal device.

### CROSS-REFERENCE TO RELATED APPLICATIONS

This application claims the benefit under 35 U.S.C. § 119(a) of Korean Patent Application No. 2005-2169, filed Jan. 10, 2005 in the Korean Intellectual Property Office, the entire contents of which are hereby incorporated by reference.

### BACKGROUND OF THE INVENTION

1. Field of the Invention

The present invention relates to an image forming device for transmitting and receiving an email message and a method for doing the same. More particularly, the present invention relates to an image forming device which, upon receiving an email message requesting transmission of pre-stored data, prepares and transmits an email message attaching the requested data, and a method for doing the same.

2. Description of the Related Art

As the internet has become wide-spread, internet-related technologies and products have been rapidly developed and have become popular. Networked image forming devices are one example of an internet-related product. An image forming device forms an image by printing data on paper, and includes such devices as a photocopier, a facsimile machine, a printer, and a multifunction peripheral. A networked image forming device includes a network card, and thus is enabled to transmit and receive data through a network. Recently-developed technologies directly transmit an email message to a networked image forming device to print data, or transmit data scanned by the image forming device to a personal computer (PC) via an email message.

In a network image forming device that is shared by a plurality of users, if a user wishes to check data files once printed, copied, or scanned, or obtain a list of such data files, the user has to go to the place where the image forming device is located to directly manipulate the image forming device and transmit an email message attaching the data file or the list of such data files to the user's email address, which is inconvenient for the user. Also, since the image forming device is typically located in a public place for easy access by the plurality of users, a person who does not have authorization to use the image forming device may manipulate the image forming device and improperly acquire the stored data.

Accordingly, there is a need for an image forming apparatus with an improved method for retrieving data stored in the image forming apparatus.

### SUMMARY OF THE INVENTION

An aspect of the present invention is to address at least the above problems and/or disadvantages and to provide at least the advantages described below. Accordingly, an aspect of the present invention is to provide an image forming device which, upon receiving an email message requesting transmission of predetermined data, checks the content of the email message and transmits the requested data, and a method for accomplishing the same.

Another aspect of the present invention is to provide an image forming device which checks a sender requesting data transmission and then determines whether to transmit the data, thereby preventing data leakage, and a method for doing the same.

In accordance with an aspect of the present invention, an image forming device includes a communication unit, a memory unit, an email processing unit, an email preparing unit, and a controller. The communication unit is connected to a network that is connected to a predetermined terminal device and performs data communication with the terminal device. The memory unit stores a pre-processed data file. The email processing unit detects the content of any email messages that are transmitted from the terminal device and received by the communication unit. The email preparing unit prepares an email message to be transmitted to the terminal device. If the content of an email message includes a data transmission command that requests sending a first data file among data files stored in the memory unit, the controller controls the email preparing unit and the communication unit to prepare and transmit an email message attaching the first data file.

In an exemplary, but not required, implementation of the present invention, if the content of the email message includes a data transmission command that requests sending a list of data files stored in the memory unit, the controller controls the email preparing unit and the communication unit to prepare and transmit an email message attaching the list of data files.

In an exemplary, but not required, implementation of the present invention, the image forming device further includes an email verification unit that verifies whether the received email message is valid by checking whether the sender's address of the email message received through the communication unit conforms to a pre-registered address.

In an exemplary, but not required, implementation of the present invention,, if the sender's address does not conform to the pre-registered address, the email verification unit verifies whether the received email message is valid by checking whether the content detected by the email processing unit includes user information necessary for user verification.

In an exemplary, but not required, implementation of the present invention, if the email verification unit verifies that the received email message is valid, the controller controls the email preparing unit and the communication unit to prepare and transmit an email message attaching the data requested by the data transmission command.

In an exemplary, but not required, implementation of the present invention, the controller checks information about accessibility which is pre-set with respect to the data requested by the data transmission command, and only if the sender of the received email message is authorized to access the data, the controller controls the email preparing unit and the communication unit to prepare and transmit an email message attaching the requested data.

In an exemplary, but not required, implementation of the present invention, if the data requested by the data transmission command is not stored in the memory unit or if the sender of the received email message is not authorized to access the data, the controller controls the email preparing unit and the communication unit to create and transmit an email message including a predetermined error message to the terminal device.

In accordance with another aspect of the present invention, a method for transmitting an email message by an image forming device which forms an image by using a data file received from a terminal device is provided. The email message transmitting method includes the steps of (a) receiving a first email message from the terminal device, (b) checking the content of the first email message, (c) if the content includes a data transmission command with respect to a first data file among pre-stored data files, preparing a second email message attaching the first data file, and (d) transmitting the second email message to the terminal device.

Preferably, but not necessarily, the method for transmitting an email message further includes the steps of (e) if the content includes a data transmission command with respect to a list of the pre-stored data files, preparing a third email message attaching the list of the pre-stored data files, and (f) transmitting the third email message to the terminal device.

In an exemplary, but not required, implementation of the present invention, implementation of the present invention, the method for transmitting an email message further includes the step of determining whether the sender's address of the first email message conforms to a pre-registered address, and if the sender's address conforms to the pre-registered address, verifying that the first email message is valid.

In an exemplary, but not required, implementation of the present invention, the method for transmitting an email message further includes the steps of, if the sender's address of the first email message does not conform to the pre-registered address, determining whether the content of the first email message includes user information for user verification, and, if the content includes user information, determining whether the user information conforms to pre-registered user information, and if the user information conforms to the pre-registered user information, verifying that the first email message is valid.

In an exemplary, but not required, implementation of the present invention, the method for transmitting an email message performs the steps (c) to (f) only if the first email message is determined to be valid.

Preferably, but not necessarily, the method for transmitting an email message performs the steps (c) to (f) only if the sender of the first email message is determined to be authorized to access the requested data as a result of checking information about accessibility pre-set with respect to the data requested by the data transmission command.

In an exemplary, but not required, implementation of the present invention, the method for transmitting an email message further includes the steps of, if the requested data is not stored, preparing an email message including a predetermined error message and then transmitting the email message to the terminal device, and if the sender of the first email message is determined to be not authorized to access the requested data, preparing an email message including the error message and then transmitting the email message.

### BRIEF DESCRIPTION OF THE DRAWINGS

The above and other objects, features, and advantages of certain exemplary embodiments of the present invention will be more apparent from the following description taken in conjunction with the accompanying drawings, in which:

FIG. 1 is a block diagram of an image forming device according to an exemplary embodiment of the present invention;

FIG. 2 is a block diagram of an image forming device according to another exemplary embodiment of the present invention;

FIGS. 3 and 4 illustrate email message formats to request the image forming device to transmit data according to exemplary embodiments of the present invention;

FIG. 5 is a flowchart of a method for transmitting an email message by an image forming device according to an exemplary embodiment of the present invention; and

FIG. 6 is a flowchart of a method for transmitting an email message by an image forming device according to another exemplary embodiment of the present invention.

Throughout the drawings, the same drawing reference numerals will be understood to refer to the same elements, features, and structures.

### DETAILED DESCRIPTION OF EXEMPLARY EMBODIMENTS

The matters defined in the description such as a detailed construction and elements are provided to assist in a comprehensive understanding of the exemplary embodiments of the invention. Accordingly, those of ordinary skill in the art will recognize that various changes and modifications of the exemplary embodiments described herein can be made without departing from the scope and spirit of the invention. Also, descriptions of well-known functions and constructions are omitted for clarity and conciseness.

The present invention will now be described in greater detail with reference to the accompanying drawings.

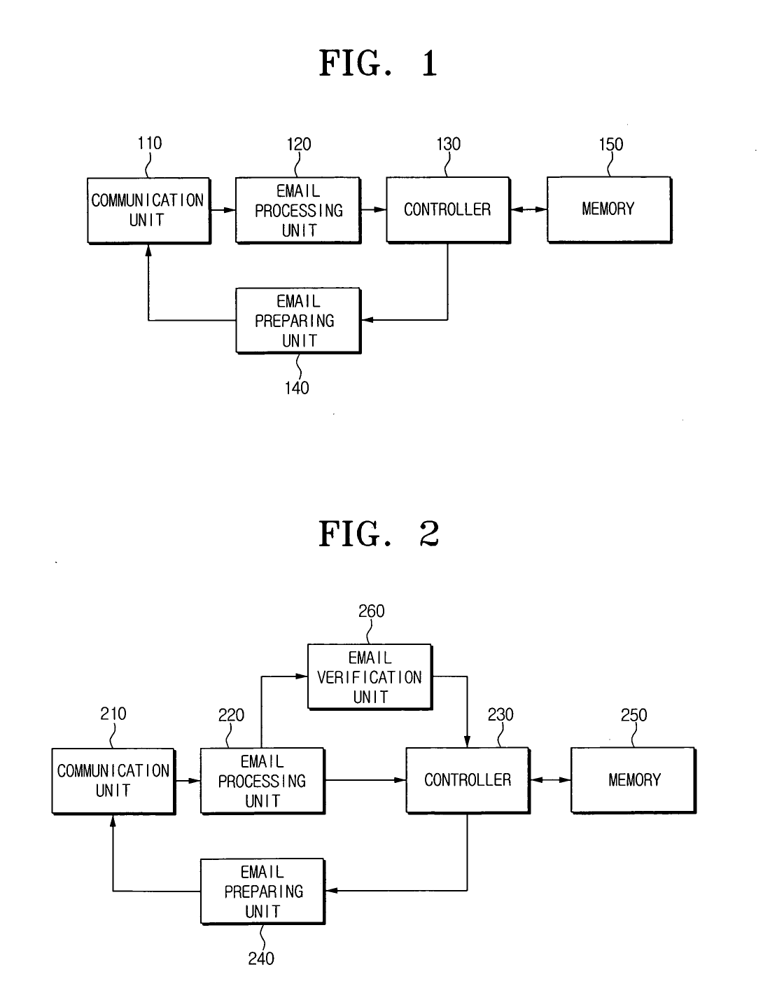

FIG. 1 is a block diagram of an image forming device according to an exemplary embodiment of the present invention. Referring to FIG. 1, the image forming device comprises a communication unit 110, an email processing unit 120, a controller 130, an email preparing unit 140, and a memory unit 150. The image forming device may be a printer, a photocopier, a scanner, a multifunction peripheral, a facsimile machine, or the like.

The communication unit 110 is connected to a network to communicate with an external device. More specifically, the communication unit 110 transmits and receives email messages through a mail server on the network. In an exemplary implementation, the mail server supports common email protocols, such as the Simple Mail Transfer Protocol (SMTP) and the Post Office Protocol, version 3 (POP3). SMTP is a protocol for email transmission, whereas POP3 is a protocol for email retrieval. That is, if email messages transmitted from an external device are stored in the server, the communication unit 110 reads the email messages stored in the server at predetermined intervals by using POP3. On the other hand, to send an email message, the communication unit 110 transmits the email message to a server for the corresponding email message account by using SMTP.

The email processing unit 120 checks the content of an email message received by the communication unit 110. More specifically, the email processing unit 120 checks the sender's address, additional information such as the receiving date, and the content of the received email message. Among these, the content of the email message is typically written in text. Accordingly, the content of the email message is parsed by reading the bit streams forming the text.

The controller 130 determines whether the content parsed by the email processing unit 120 includes a command. More specifically, the controller checks whether the message includes a ‘send’ command to transmit specific data, a ‘print’ command to print specific data, and a ‘delete’ command to delete specific data. The particular commands that the controller checks for are previously set by a manufacturer or user of the image forming device. The controller 130 records in an inner registry bit streams of data corresponding to the commands to be able to determine whether the email message includes text such as ‘send’, ‘print’ or ‘delete’.

By the same method, the controller 130 can determine target data designated by the command. The target data may be a specific data file name or a list of pre-stored data files.

The email preparing unit 140 prepares an email message to transmit it to an external device through the communication unit 110. If the content of the received email message is determined to include the ‘send’ command designating a first data file, the controller 130 controls the email preparing unit 140 to prepare an email message attaching the first data file. The image forming device then transmits the prepared email message to the sender who sent the email message.

The memory unit 150 stores various data files which have been processed by the image forming device. The controller 130 creates a list containing the names of all data files if the received email message requests the list of data files, and then controls the email preparing unit and the communication unit 110 to attach the list to the prepared email message and reply to the received email message.

If the received email message requests data deletion or data printing, the image forming device deletes or prints the data file stored in the memory unit 150 using a print engine. The print engine for printing the data file is not described in detail or illustrated for the sake of brevity.

FIG. 2 is a block diagram illustrating an image forming device according to another exemplary embodiment of the present invention. Referring to FIG. 2, the image forming device comprises a communication unit 210, an email processing unit 220, a controller 230, an email preparing unit 240, a memory unit 250 and an email verification unit 260. Except for the email verification unit 260, the components of this image forming device are substantially similar to those of FIG. 1, and therefore a detailed descriptions of these elements will not be repeated.

The email verification unit 260 checks the additional information parsed by the email processing unit 220 and verifies whether the email message is valid based on the additional information. More specifically, if the sender's address of the received email message is determined to conform to a pre-registered address, the email message is determined to be valid. If not, the email message is determined to be invalid and the controller 230 does not reply to the email message accordingly.

If the sender's address does not conform to the pre-registered address, the email verification unit 260 determines whether the content of the message includes user information verifying that the sender is a valid user. The user information includes an email address or ID, and a password, a registration number, or a membership number corresponding to the email address or ID. If the sender's address does not conform to the pre-registered address but the user information is determined to be valid, the email message is determined to be valid. The controller 230 replies to the email message only when the email message is verified by the email verification unit 260.

If there is no target data in the memory unit 250, the controller 230 controls the email preparing unit 240 and the communication unit 210 to prepare and transmit an email message having an alarm message indicating that the requested data does not exist in the memory unit 250.

A user may not have access with respect to a specific data even if the user is authorized to use the image forming device. That is, the image forming device may be set up to deny a user access to specific, secret data stored in the image forming device. The information about accessibility/inaccessibility is stored in the memory unit 250 along with the data files. If a valid email message is received but the user is not authorized to access the requested data, the controller 230 controls the email preparing unit 240 and the communication unit 210 to prepare an email message having an error message indicating that the data is not accessible and reply to the user who sent the email message.

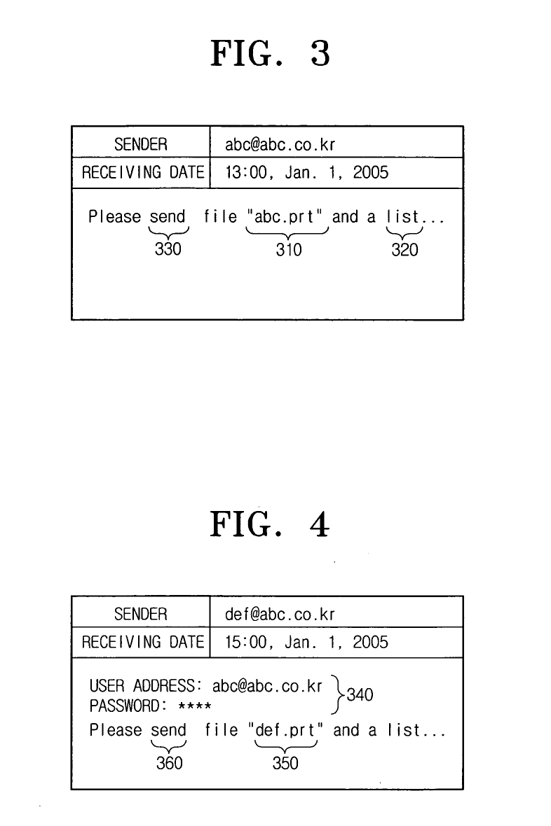

FIG. 3 illustrates one exemplary format of an email message transmitted to the image forming device of the present invention. Referring to FIG. 3, a user transmits an email message including a ‘send’ command to request transmission of target data 310, 320 to the image forming device.

The image forming device reads out and parses the bit streams forming the text content of the email message. When the data file name ‘abc.prt’, the text ‘list’ and the command ‘send’ are checked, the image forming device comprehends that the file ‘abs.prt’ and the ‘list’ are to be transmitted. Accordingly, the image forming device prepares an email message attaching the file ‘abc.prt’ and the ‘list’ of all files and replies to the email message.

FIG. 4 illustrates another exemplary format of an email message transmitted to the image forming device. Referring to FIG. 4, the user adds user information 340 necessary for verification to the content of the email message. In FIG. 4, the user information 340 is a user email address and a password. Together with the user information 340, the target data ‘def.prt’ and the send’ command are also recorded.

The image forming device verifies whether the email message is valid by checking whether the sender email address ‘def@abc.co.kr’ conforms to the pre-registered sender's address. If the received email address does not conform to the pre-registered address but the user information 340 conforms to pre-registered user information, the image forming device verifies that the email message is valid. Accordingly, the image forming device prepares and transmits an email message attaching the file ‘def prt’.

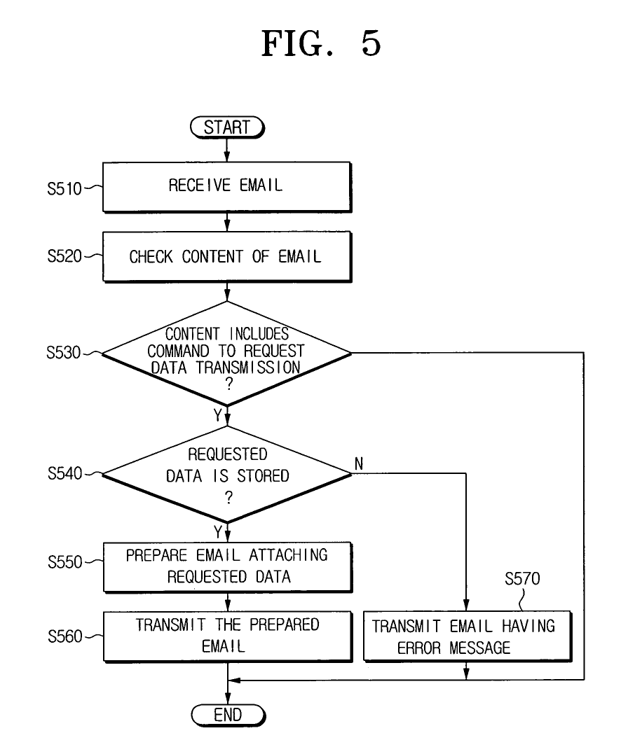

FIG. 5 is a flowchart of a method for transmitting an email by an image forming device according to an exemplary embodiment of the present invention. Referring to FIG. 5, when an email message is received at operation S510, the image forming device checks the content of the received email message at operation S520.

It is determined whether the content of the email message includes a command to request data transmission at operation S530. If there is no command to request data transmission, the image forming device performs a pre-set operation, such as a printing operation. If there is a command to request data transmission, the image forming device determines whether the requested data is stored in the memory units 150, 250 at operation S540.

If the requested data is stored, the image forming device prepares an email message attaching the requested data at operation S550, and transmits the email message at operation S560. If the requested data is not stored, the image forming device prepares and transmits an email message including an error message at operation S570.

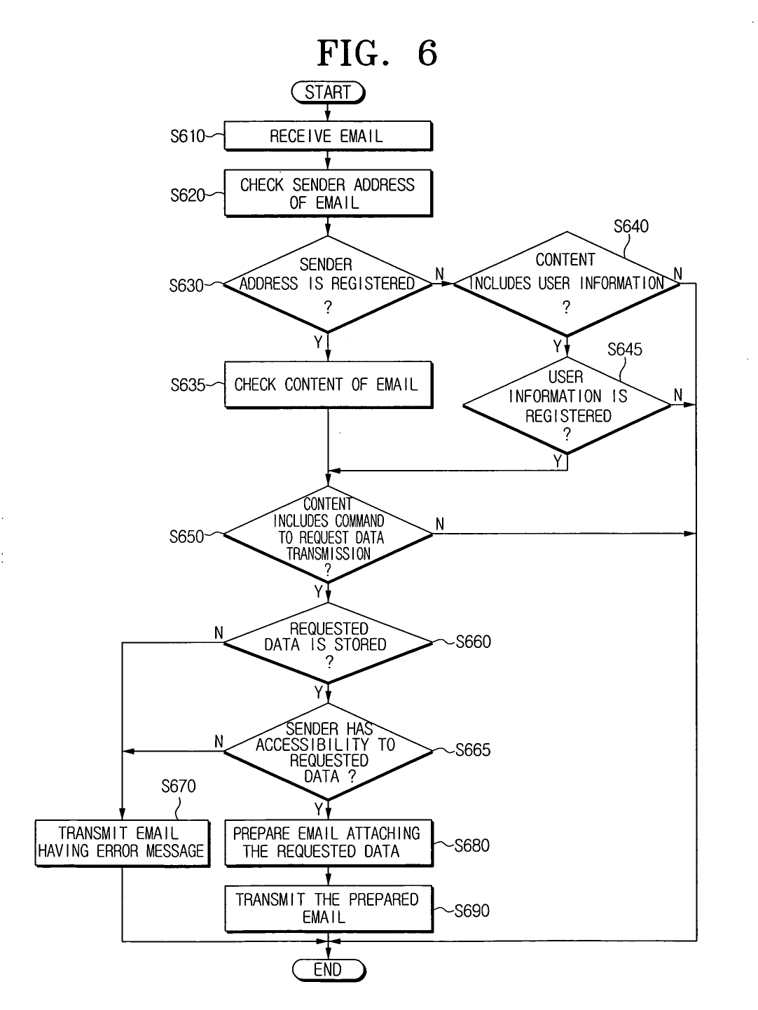

FIG. 6 is a flowchart of a method for transmitting an email by an image forming device according to another exemplary embodiment of the present invention. Referring to FIG. 6, when an email message is received at operation S610, the image forming device checks the sender's address of the email message at operation S620. The image forming device determines whether the received sender's address conforms to the pre-registered user address at operation S630.

If the sender's address does not conform to the pre-registered user address, the image forming device checks the content of the email message and determines whether the content includes user information at operation S640. If user information is included in the content, it is determined whether the received user information conforms to the pre-registered user information at operation S645. If the received user information conforms to the pre-registered information, it is determined whether the content includes a predetermined command to request data transmission at operation S650. Meanwhile, if the sender's address conforms to the pre-registered address at operation S630, the content of the email message is checked at operation S635 and it is determined whether the content includes a command to request data transmission at operation S650.

If the command to request data transmission is included in the content, it is determined whether the requested data is stored at operation S660. If the data is not stored, the image forming device prepares and transmits an email message including an error message at operation S670.

If the requested data is stored, it is determined whether the sender is authorized to access the data at operation S665. If the image forming device verifies that the user is authorized to access the data, it prepares an email message attaching the requested data at operation S680 and replies to the received email message at operation S690. In this case, the requested data is a data file itself or a list of files. Alternatively, the requested data may be a sender or creator of the data file, or a print date.

If the sender is not authorized to access the requested data, the image forming device prepares and transmits an email message including an error message at operation S670.

According to the exemplary embodiments of the present invention as described above, when an email message requesting transmission of specific data is received, the image forming device checks the content of the email message, prepares an email message attaching the requested data and replies to the received data. Accordingly the user easily copies data from the image forming device to the user's PC. Also, the image forming device may verify the email message so that data stored in the image forming device is provided to only users who are authorized to access the data. Accordingly, data leakage can be prevented.

While the invention has been shown and described with reference to certain exemplary embodiments thereof, it will be understood by those skilled in the art that various changes in form and details may be made therein without departing from the spirit and scope of the invention as defined by the appended claims.

What is claimed is:

1. An image forming device comprising:
a communication unit connected to a network connected to a terminal device, the communication unit performing data communication with the terminal device;
a memory unit that stores a data file;
an email processing unit that detects the content of at least one email message transmitted from the terminal device and received through the communication unit,;
an email preparing unit that prepares an email message to be transmitted to the terminal device; and
a controller that, if the content of the email message comprises a data transmission command to request sending of a first data file among data files stored in the memory unit, controls the email preparing unit and the communication unit to prepare an email message attaching the first data file and then transmit the email message to the terminal device.

2. The image forming device as claimed in claim 1, wherein
if the content of the email message comprises a data transmission command to request sending of a list of data files stored in the memory unit, the controller controls the email preparing unit and the communication unit to prepare an email message attaching the list of data file and then transmit the email message to the terminal device.

3. The image forming device as claimed in claim 2, further comprising
an email verification unit that verifies whether the received email message is valid by checking whether a sender's address of the email message conforms to a pre-registered address.

4. The image forming device as claimed in claim 3, wherein
if the sender's address does not conform to the pre-registered address, the email verification unit verifies whether the received email message is valid by checking whether the content detected by the email processing unit comprises user information necessary for user verification.

5. The image forming device as claimed in claim 4, wherein
only if the email verification unit verifies that the received email message is valid, the controller controls the email preparing unit and the communication unit to prepare and transmit an email message attaching the data requested by the data transmission command.

6. The image forming device as claimed in claim 5, wherein
the controller checks information about accessibility to the data requested by the data transmission command, and only if the sender of the received email message is authorized to access the data, the controller controls the email preparing unit and the communication unit to prepare and transmit an email message attaching the requested data.

7. The image forming device as claimed in claim 6, wherein
if the data requested by the data transmission command is not stored in the memory unit or if the sender of the received email message is not authorized to access the data, the controller controls the email preparing unit and the communication unit to create an email message comprising a predetermined error message and then transmit the email message to the terminal device.

8. A method for transmitting an email message in an image forming device which forms an image by using a data file received from a terminal device, the method comprising the steps of:
(a) receiving a first email message from the terminal device;
(b) checking a content of the first email message;
(c) if the content comprises a data transmission command with respect to a first data file among pre-stored data files, preparing a second email message attaching the first data file; and
(d) transmitting the second email message to the terminal device.

9. The method for transmitting an email message as claimed in claim 8, further comprising the steps of:
(e) if the content comprises a data transmission command with respect to a list of the pre-stored data files, preparing a third email message attaching the list of the pre-stored data files; and
(f) transmitting the third email message to the terminal device.

10. The method for transmitting an email message as claimed in claim 9, further comprising the steps of:
determining whether a sender's address of the first email message conforms to a pre-registered address; and
if the sender's address conforms to the pre-registered address, verifying that the first email message is valid.

11. The method for transmitting an email message as claimed in claim 10, further comprising the steps of:
if the sender's address of the first email message does not conform to the pre-registered address, determining whether the content of the first email message comprises user information for user verification;
if the content comprises user information, determining whether the user information conforms to a pre-registered user information; and
if the user information conforms to the pre-registered user information, verifying that the first email message is valid.

12. The method for transmitting an email message as claimed in claim 11, wherein
steps (c) to (f) are performed only if the first email message is determined to be valid.

13. The method for transmitting an email message as claimed in claim 12, wherein
steps (c) to (f) are performed only if the sender of the first email message is determined to be authorized to access the requested data as a result of checking pre-set accessibility information with respect to the data requested by the data transmission command.

14. The method for transmitting an email message as claimed in claim 13, further comprising the steps of:
if the requested data is not stored, preparing an email message comprising a predetermined error message and then transmitting the email message to the terminal device; and
if the sender of the first email message is determined to be not authorized to access the requested data, preparing an email message comprising the error message and then transmitting the email message.

15. A method for transmitting an email message in an image forming device which forms an image by using a data file, the method comprising the steps of:
(a) receiving a first email message;
(b) verifying whether the first email message is valid; and
(c) determining if the email message comprises a data transmission command with respect to a data file, and, if so, preparing and transmitting a second email message attaching the data file.

16. The method for transmitting an email message as claimed in claim 15, further comprising the steps of:
(d) determining if the email message comprises a data transmission command with respect to a list of stored data files, and, if so, preparing and transmitting a third email message attaching the list of stored data files.

17. The method for transmitting an email message as claimed in claim 16, wherein the step (b) of verifying whether the first email message is valid comprises the steps of:
(b1) determining whether a sender's address of the first email message conforms to a pre-registered address;
(b2) if the sender's address conforms to the pre-registered address, verifying that the first email message is valid;
(b3) if the sender's address of the first email message does not conform to the pre-registered address, determining whether the first email message comprises user information for user verification;
(b4) if the first email message comprises user information, determining whether the user information conforms to a pre-registered user information; and
(b5) if the user information conforms to the pre-registered user information, verifying that the first email message is valid.

18. The method for transmitting an email message as claimed in claim 17, wherein
steps (c) to (d) are performed only if the first email message is determined to be valid.

19. The method for transmitting an email message as claimed in claim 18, wherein
steps (c) to (d) are performed only if the sender of the first email message is determined to be authorized to access the requested data as a result of checking accessibility information with respect to the data requested by the data transmission command.

20. The method for transmitting an email message as claimed in claim 19, further comprising the step of:
preparing and transmitting an email message comprising a predetermined error message if the sender of the first email message is determined not to be authorized to access the requested data or if the requested data is not stored in the image forming apparatus.
